(19) United States
(12) Patent Application Publication
(10) Pub. No.: US 2006/0102874 A1
(43) Pub. Date: May 18, 2006

(54) Water treatment dechlorination tablet and production method

(75) Inventor: Yuping Zheng, Fushun (CN)

Correspondence Address: DRIGGS, LUCAS, BRUBAKER & HOGG CO., L.P.A., 38500 CHARDON ROAD, DEPT. DLBH, WILLOUGBY HILLS, OH, 44094, US

(73) Assignee: Fushun Watech Environmental Science and Technology Co. LTD, Fushun (CN)

(21) Appl. No.: 11/083,254

(22) Filed: Mar. 17, 2005

(30) Foreign Application Priority Data
Nov. 15, 2004 (CN) 200410068148.5

(51) Int. Cl. C09K 3/00

(52) U.S. Cl. 252/182.11

(57) ABSTRACT

A dechlorination tablet for water and wastewater treatment contains 70 to 91 weight percent active sodium sulfite, 0.5 to 4.2 weight percent mixture solution of color liquid and liquid sugar binder, 0.05 to 1 weight percent one type of stearate salt used as dissolution rate control chemical, 0.05 to 1 weight percent another type of stearate salt used as mold release chemical, and 2 to 3.75 weight percent inert material, such as talc powder. The method of making the tablet comprises mixing the materials completely, pouring the mixture into a mold of a tabletting press, and pressing the mixture into a tablet at a pressure of between 7,000 kilograms and 25,000 kilograms. The density of the formed tablet is from 1.7 to 2.1 gram/cm³. Then, the formed tablet is dried between 70° C. and 130° C. for between one-half and three hours.

### CROSS REFERENCE TO RELATED APPLICATION

This application claims priority of Chinese application Serial No. 200410068148.5, filed Nov. 15, 2004, for WATER TREATMENT DECHLORINATION TABLET AND PRODUCTION METHOD.

### FIELD OF THE INVENTION

The present invention relates generally to adding a special designed and produced agent to water, or industrial water, or chlorinated wastewater for enhancing its quality. In particular, the present invention is directed to an agent that is used to remove halogens, such as chlorine, bromine and iodine, from water or wastewater, and the method of making the agent.

### BACKGROUND OF THE INVENTION

The quality of water and treated wastewater is affected by non-volatile halogens, such as chlorine, bromine and iodine, existing in water and chlorinated wastewater. U.S. Pat. No. 4,364,835 describes the application of sulfur dioxide, or soluble sulfite, or bisulfite for removing non-volatile chlorine residual from water. This type of non-volatile chlorine residual exists in chlorinated drink water, treated sewage and industrial wastewater. Sulfite salts can be applied to remove chlorine residual from water, or at least destroy most non-volatile chlorine residuals. U.S. Pat. No. 4,816,177 uses a protein containing, organic gel forming binder to form one type of sodium sulfite tablet that can be applied to remove chlorine from water and chlorinated wastewater. In practical application, the protein containing, organic gel forming binder is released into water with dissolved tablet material. Foams and small white pieces of floating material exist on the surface of dechlorinated water. Therefore, the secondary pollution, visual pollution, is caused by the binder and the other inert material in the tablets. The dissolution rate of this type of dechlorination tablet depends upon the amount of binder used in a tablet and the production pressure. At present, the dissolution rate of some dechlorination tablets on the market cannot be easily adjusted for different applications.

### BRIEF DESCRIPTION OF THE INVENTION

The present invention supplies a new type of dechlorination tablet that minimizes secondary pollution and avoids foam and small white pieces of floating material. The dissolution of the tablet produced by the present invention is controllable. Another technical point of the present invention is the production method of the new dechlorination tablet.

The present invention uses a technology to produce one type of dechlorination agent in tablet shape for water treatment. This type of water treatment agent contains 70 to 91 weight percent active sodium sulfite ingredients, 0.5 to 4.2 weight percent mixture of color liquid and liquid sugar binder, 0.05 to 1 weight percent stearate salt used as a dissolution rate control chemical, and 2 to 3.75 weight percent inert material, such as talc powder, etc.

In order to increase the ease of release of the tablet from the mold, the tablet in the present invention also contains 0.05 to 1 weight percent of another type of stearate salt as a mold release chemical.

The liquid mixture of color liquid and liquid sugar binder mentioned in the present invention is a liquid solution of a small quantity of a food dye, liquid sugar and water.

The liquid sugar binder can be made from one or more liquid food sugar mixtures, such as liquid barley sugar mixture, liquid sucrose mixture, liquid lactose mixture, liquid beet sugar mixture, liquid corn sugar mixture and liquid glucose mixture.

The regular liquid corn sugar mixture can be made of liquid sugar, liquid corn sugar, maltodextrin, glycol alginic acid, carboxymethylcellulose, sodium chloride, diolefinic acid, sodium benzoate, sodium metaphosphate, natural or artificial flavor agent, color agent and soft water.

The regular liquid sugar mixture can be made of liquid sugar, glycol alginic acid, carboxymethylcellulose, sodium chloride, diolefinic acid, sodium benzoate, sodium metaphosphate, natural or artificial sweet flavor agent, color agent and soft water.

The regular liquid barley sugar mixture can be made of liquid sugar, liquid corn sugar, liquid barley sugar, liquid maltodextrin, glycol alginic acid, carboxymethylcellulose, diolefinic acid, sodium benzoate, sodium metaphosphate, natural or artificial sweet flavor agent, color agent and soft water.

The dissolution rate control chemical mentioned in the present invention can be selected from one or more stearate salts, such as magnesium stearate, calcium stearate, barium stearate, lead stearate, zinc stearate, sodium stearate, strontium stearate, cadmium stearate, lithium stearate, and aluminum stearate.

The weight percent of active sodium sulfite in the tablet is higher than normal dechlorination tablets. A high weight percent of sodium sulfite can be achieved, for example, 80 to 90 weight percent.

The dechlorination tablet of the present invention can be in the shape of a tablet or pillar. The diameter is from 30 millimeters to 80 millimeters, and the thickness or height is from 10 millimeters to 30 millimeters.

One production method regarding above water treatment dechlorination tablet is presented here. Active sodium sulfite, a mixture solution of color water and liquid sugar binder, one type of stearate salt used as dissolution rate control chemical, another type of stearate salt used as a mold release chemical, and inert materials are mixed together completely. The mixture is placed in a mold and is then pressed in a tabletting press under 7,000 to 25,000 kg pressure force. The density of the formed tablet is from 1.7 to 2.1 gram/cm³. The finished tablet is dried in an oven under the temperature of between 70° C. and 130° C. The baking time is between one-half and three hours. After cooling down, the dried tablet is ready for wrapping and packing.

The dechlorination tablet of the present invention is made from sodium sulfite as the active ingredient, a mixture solution of color liquid and liquid sugar binder, one type of stearate salt used as dissolution rate control chemical, another type of stearate salt used as a mold release chemical and an inert material. The tablet is used for removing halogens from liquid fluid media. The liquid sugar binder minimizes the occurrence of foam and small white pieces of floating material during water dechlorination. The secondary pollution of treated water is minimized. High weight percent of sodium sulfite ensures that chlorine residual can be removed from water or chlorinated wastewater effectively. The tablet dissolution rate is controlled or adjusted by one type of stearate salt that is used as a dissolution rate control chemical. The tablet is evenly dissolved in the water or chlorinated wastewater, and the tablet dissolution rate is controlled in a required range. Therefore, unnecessary consumption of tablets is reduced. The tablet has good strength and shape which reduce the chances of tablet damages during shipping time.

### BRIEF DESCRIPTION OF THE DRAWINGS

FIG. 1 is a drawing of a dechlorination tablet.

FIG. 2 is a drawing of a dispensing apparatus with dechlorination tablets.

### DETAILED DESCRIPTION OF THE INVENTION

### EXAMPLE 1

The present invention is described in detail through the following example. The dechlorination tablet for water treatment contains 70 to 91 weight percent active sodium sulfite, 0.5 to 4.2 weight percent mixture solution of color liquid and liquid sugar binder, 0.05 to 1 weight percent stearate salt used as dissolution rate control chemical, and 2 to 3.75 weight percent inert materials, such as talc powder. For ease of releasing the tablet from a mold, the dechlorination tablet further contains 0.05 to 1 weight percent of another type of stearate salt used as a mold release chemical. The mentioned mixture solution of color liquid and liquid sugar binder is made from regular liquid food sugar and a small quantity of a food dye. The liquid sugar can be selected from one or more liquid food sugar mixtures, such as liquid barley sugar mixture, liquid sucrose mixture, liquid lactose mixture, liquid beet sugar mixture, liquid corn sugar mixture and liquid glucose mixture.

The regular liquid corn sugar mixture can be made of liquid sugar, liquid corn sugar, maltodextrin, glycol alginic acid, carboxymethylcellulose, sodium chloride, diolefinic acid, sodium benzoate, sodium metaphosphate, natural or artificial flavor agent, color agent and soft water. The regular liquid sugar mixture can be made of liquid sugar, glycol alginic acid, carboxymethylcellulose, sodium chloride, diolefinic acid, sodium benzoate, sodium metaphosphate, natural or artificial sweet flavor agent, color agent and soft water. The regular liquid barley sugar mixture can be made of liquid sugar, liquid corn sugar, liquid barley sugar, liquid maltodextrin, glycol alginic acid, carboxymethylcellulose, diolefinic acid, sodium benzoate, sodium metaphosphate, natural or artificial sweet flavor agent, color agent and soft water.

The stearate salt used as a dissolution rate control chemical can be selected from one or more stearate salts, such as magnesium stearate, calcium stearate, barium stearate, lead stearate, zinc stearate, sodium stearate, strontium stearate, cadmium stearate, lithium stearate, and aluminum stearate. The weight percent of active sodium sulfite in the tablet is higher than normal dechlorination tablets. A high weight percent of sodium sulfite can be achieved, such as 80 to 90 weight percent. The agent can be in the shape of a tablet or pillar. The diameter is from 30 millimeters to 80 millimeters, and the thickness or height is from 10 millimeters to 30 millimeters.

### Production Example

Three grams of carbohydrate (food grade liquid corn sugar mixture), two grams of color solution (food dye and water), 0.3 grams of stearate salt (magnesium stearate), one gram of stearate salt used as mold release chemical are weighted and mixed completely to make a liquid mixture. Then, the mixture is further mixed completely with 133.7 grams of dehydrated sodium sulfite powder that contains 96 weight percent sodium sulfite and four percent impurity, and five grams of inert material (talc powder). Then, the above mixture is poured into a tablet mold of a tabletting press. 10,000 kilograms of pressure force is applied to press the mixture into a tablet. The tablet is 66.68 mm in diameter and 20.6 mm in thickness. The density of the tablet is 1.9 gram/cm³. The formed tablet is placed in an oven where the temperature is controlled at 90° C. After one hour baking, the tablet is taken out from the oven and placed at a dry place for cooling down. After 30 minutes, the tablet is ready for wrapping and packing.

### Dissolution Rate Test Example

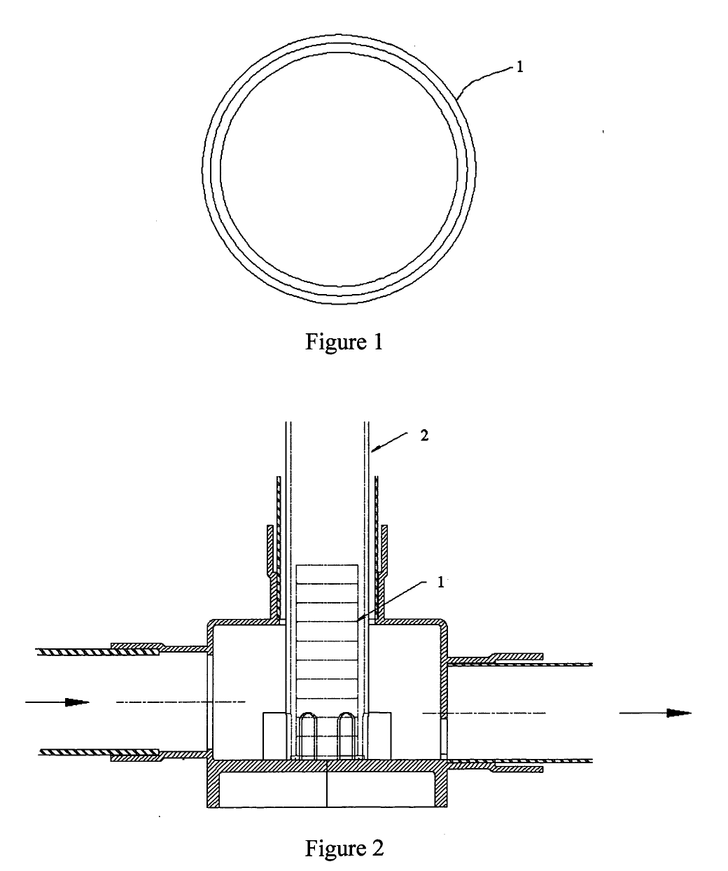

The dechlorination tablets made from the procedure of the Production Example is shown in FIG. 1. A tablet dispensing apparatus for adding dechlorination tablets is shown in FIG. 2. The tablets are placed into a feeder tube that is inserted into a feeder housing. Certain flow rate of water is induced into the dechlorination dispensing apparatus. The water contacts the tablets in the feeder tube. Under water abrasion force and water dissolution force, the tablets are gradually dissolved into water. In water and wastewater treatment processes, the tablet dissolution rate is required to be controlled in a certain range. In the present invention, the dechlorination tablet dissolution rate can be controlled by dissolution control chemical. In the present invention, the dissolution rate can be controlled based on different application requirements. The dissolution rate of the dechlorination tablet is directly in a reversed relationship with the weight percent of dissolution rate control chemical. Under a certain flow rate, the dechlorination tablets with different ratios of dissolution rate control chemical have been tested for three hours. The tablets' dissolution results in three hours are listed in Table 1.

TABLE 1
Dissolution Rate Variation of Dechlorination Tablets

| | Dissolution Rate Control Chemical (%) | | | | | | | |
|---|---|---|---|---|---|---|---|---|
| | 0 | 0.07 | 0.1 | 0.2 | 0.28 | 0.35 | 0.69 | 2.8 |
| Dissolution | 118 | 108 | 96 | 72 | 57 | 46 | 40 | 35 |
| Rate | | | | | | | | |
| (g/3 Hr) | | | | | | | | |

From the test results shown in Table 1, the dissolution rate of the dechlorination tablets depends upon the dissolution rate control chemical weight percent in the tablet. When the dissolution rate control chemical is not used, the total dissolution rate in the first three hours is 118 grams. When 0.69 weight percent dissolution rate control chemical is used, the total dissolution rate in the first three hours drops to 40 grams. The tablet dissolution rate is reduced when the dissolution rate control chemical is increased.

By observing the dechlorinated water at the end of the test, foams and white floating material are not found in the water dechlorinated by the novel tablets of the present invention.

The above description is only the basic instruction of the present invention. Any equivalent change based on the present invention technical plan belongs to the protection field or range of the present invention as covered by the claims hereof.

What is claimed is:

1. A water treatment dechlorination tablet agent containing between 70 and 91 weight percent active sodium sulfite, 0.5 to 4.2 weight percent mixture solution of color liquid and liquid sugar binder, 0.05 to 1 weight percent of a first type of stearate salt used as a dissolution rate control chemical, and 2 to 3.75 weight percent inert material.

2. The water treatment tablet agent of claim 1, wherein said tablet agent contains 0.05 to 1 weight percent mold release agent made from a second type of stearate salt.

3. The water treatment tablet agent of claim 1, wherein said color liquid comprises food dye and water.

4. The water treatment tablet agent of claim 1, wherein said liquid sugar binder is at least one liquid sugar mixture selected from the group comprising liquid barley sugar mixture, liquid sucrose mixture, liquid lactose mixture, liquid beet sugar mixture, liquid corn sugar mixture and liquid glucose mixture.

5. The water treatment tablet agent of claim 4, wherein said liquid sugar binder comprises a liquid corn sugar mixture made from liquid sugar, liquid corn sugar, maltodextrin, glycol alginic acid, carboxymethylcellulose, sodium chloride, diolefinic acid, sodium benzoate, sodium metaphosphate, natural or artificial flavor agent, color agent and soft water.

6. The water treatment tablet agent of claim 4, wherein said liquid sugar binder comprises a liquid sugar mixture made from liquid sugar, glycol alginic acid, carboxymethylcellulose, sodium chloride, diolefinic acid, sodium benzoate, sodium metaphosphate, a sweet flavor agent, a color agent and soft water.

7. The water treatment tablet agent of claim 4, wherein said liquid sugar binder comprises liquid barley sugar mixture made from liquid sugar, liquid corn sugar, liquid barley sugar, liquid maltodextrin, glycol alginic acid, carboxymethylcellulose, diolefinic acid, sodium benzoate, sodium metaphosphate, natural or artificial sweet flavor agent, color agent and soft water.

8. The agent of claim 1, wherein said dissolution rate control chemical comprises stearate salt, selected from the group of magnesium stearate, calcium stearate, barium stearate, lead stearate, zinc stearate, sodium stearate, strontium stearate, cadmium stearate, lithium stearate, aluminum stearate and mixtures thereof.

9. The water treatment tablet agent of claim 1, wherein said weight percent of active sodium sulfite ingredient is from 80 to 91.

10. The agent of claim 1 wherein the diameter of the tablet is from 30 millimeters to 80 millimeters and the thickness is from 10 millimeters to 30 millimeters.

11. The water treatment tablet agent of claim 1 wherein a mixture is made by completely blending together active sodium sulfite, a mixture solution of color water and liquid sugar binder, a first type of stearate salt used as dissolution rate control chemical, a second type of stearate salt used as a mold release agent, and inert materials, placing the mixture in a mold, pressing the mixture in a tabletting press at 7,000 to 25,000 kg pressure force to form a tablet having a density of from 1.7 to 2.1 gram/cm³ and drying the finished tablet in an oven at the temperature of between 70° C. and 130° C. for between one-half and three hours.

12. A process of preparing a water treatment dechlorination tablet having a controlled dissolution rate comprising the steps of:
a) forming a mixture of:
between 70 and 91 weight percent sodium sulfite;
between 0.5 and 4.2 weight percent of a binder comprising a color liquid and liquid sugar;
between 0.05 and 1 weight percent of a dissolution rate control agent comprising at least one stearate salt;
between 0.05 to 1 weight percent of a second stearate salt as a mold release agent; and
between 2 and 3.75 weight percent of inert material;
b) pressing a given quantity of the mixture at a pressure to form a tablet; and
c) drying the tablet.

13. The process according to claim 12 wherein the step of pressing the mixture comprises compressing in a tabletting press with a force between from 7000 kg and 25,000 kg pressure force.

14. The process according to claim 13 wherein the tablet is dried at a temperature of between about 70° C. and about 130° C. for a period of between about one-half and about three hours whereupon the finished tablet has a density of from 1.7 to 2.1 gram/cm³.

15. The wherein said color liquid comprises food dye and water.

16. The process according to claim 12, wherein said liquid sugar binder is at least one liquid sugar mixture selected from the group comprising liquid barley sugar mixture, liquid sucrose mixture, liquid lactose mixture, liquid beet sugar mixture, liquid corn sugar mixture and liquid glucose mixture.

17. The process according to claim 12 wherein said dissolution rate control chemical comprises stearate salt, selected from the group of magnesium stearate, calcium stearate, barium stearate, lead stearate, zinc stearate, sodium stearate, strontium stearate, cadmium stearate, lithium stearate, aluminum stearate and mixtures thereof.

18. The process according to claim 12 wherein the weight percent of active sodium sulfite ingredient is from 70 to 91.

19. The process according to claim 14 wherein the diameter of the tablet is from 30 millimeters to 80 millimeters, and the thickness is from 10 millimeters to 30 millimeters.
